(19) United States
(12) Patent Application Publication
(10) Pub. No.: US 2006/0175896 A1
(43) Pub. Date: Aug. 10, 2006

(54) Electric hydraulic disc trailer brake

(76) Inventor: Eugene Eric Isaacson, Gwinn, MI (US)

Correspondence Address: EUGENE ISAACSON, P.O. BOX 1025 141 TAMARACK, GWINN, MI, 49841, US

(21) Appl. No.: 11/050,597

(22) Filed: Feb. 4, 2005

(51) Int. Cl. B60T 7/20

(52) U.S. Cl. 303/124

(57) ABSTRACT

This invention relates to an improved braking system under severe use, and wet conditions. Which is a result of a hydraulic disc, brake system. It also allows the user to continue using an existing in cab controller which is cost saving. Or, purchase a low cost drum brake controller. Also, each wheel is an independent function, in case of failure it is safer because only one wheel will be affected.

The Electric Hydraulic Disc Brake is operated in the tow vehicle by an electric brake controller. This controller is purchased or previously installed. Magnets ride on the inside surface of the disc brake rotor, or installed rotating disc, when energized by the tow vehicle operator. It may be operated separately (trailer only), or in conjunction with the tow vehicle brake foot pedal. The magnets advance in the direction of rotor movement when energized. Connected to the magnet bracket is a linkage that depresses the piston in a brake actuator cylinder, creating hydraulic pressure in the piston of the hydraulic brake caliper. Thus, pinching the rotor and slowing the wheel.

The benefit is more effective braking, by allowing the trailer hydraulic disc brake to be operated separately from the tow vehicle, reducing trailer sway. Resulting in more braking power on each wheel and little, or no, brake fading with extreme use. Also, more effective braking after being submerged in water.

References cited:

| | | |
|---|---|---|
| 6,079,792 | JUNE 2000 | Kessler |
| 6,652,038 | NOVEMBER 2003 | Frye |
| 6,666,527 | DECEMBER 2003 | Gill and Swanson |

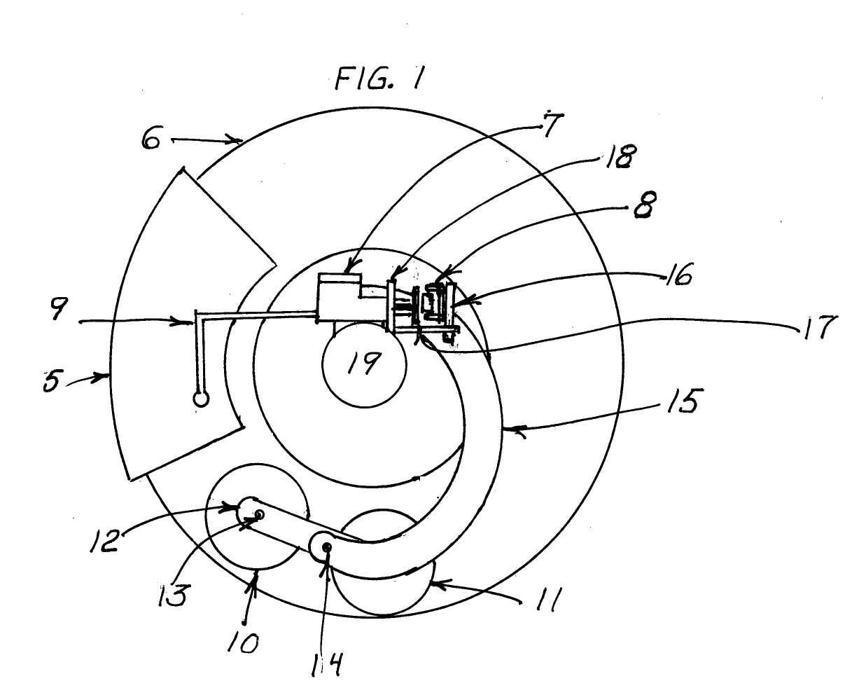

FIG. 1: Shows a view of the actuator cylinder 7 and assembly looking down the axle 19 from the center of the trailer. This view blocks some of the magnet arm 15 assembly, mounting bracket 23 and Push Rod 20.

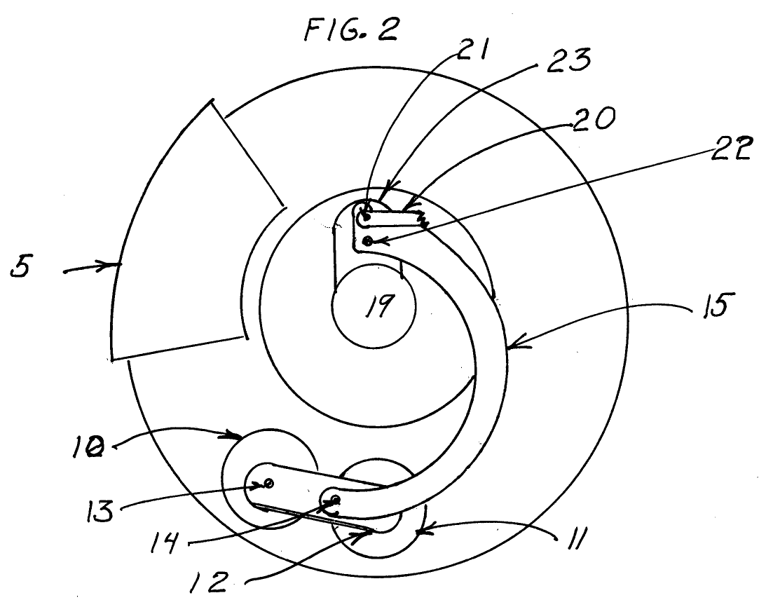

FIG. 2: Shows the magnet arm assembly 15-20-23 installed on pins 21 and 22 and magnets 10 and 11, joined by bracket 12—mounted with pins 13 and 14 on magnet arm 15 with the actuator cylinder assembly removed.

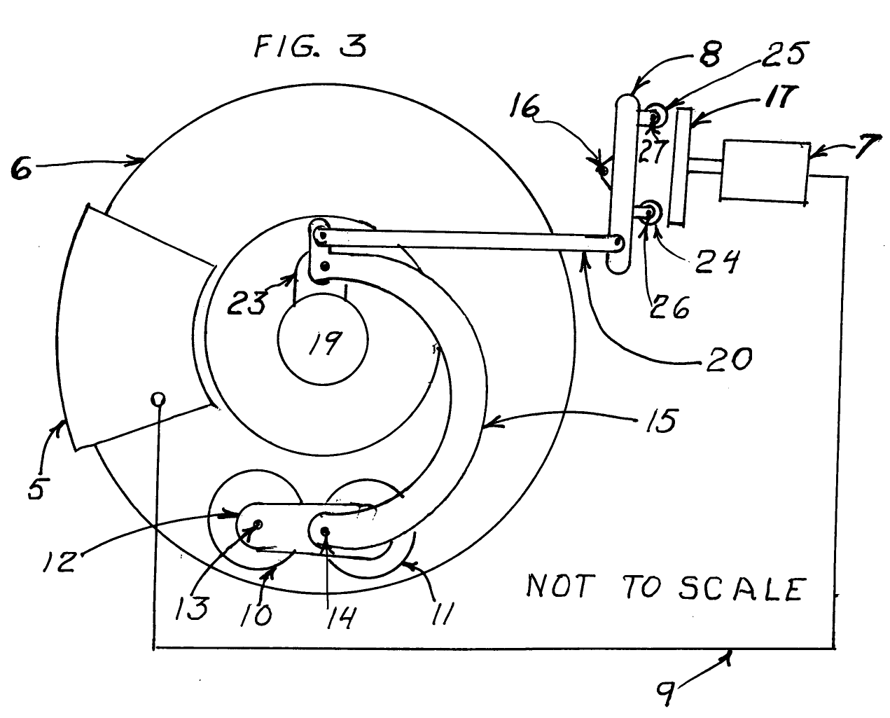

FIG. 3: A schematic type drawing showing the function of the invention energized electric magnets 10 and 11 move with the rotating disc 6. The magnet arm 15 then will push or pull rod “20”, operating rocker “8” on pin 16, pushing plunger “17” with roller 24 and 25 mounted on pin 26 and 27, pushing a piston in the hydraulic cylinder 7, creating pressure through hydraulic pressure line 9 to operate brake caliper 5.

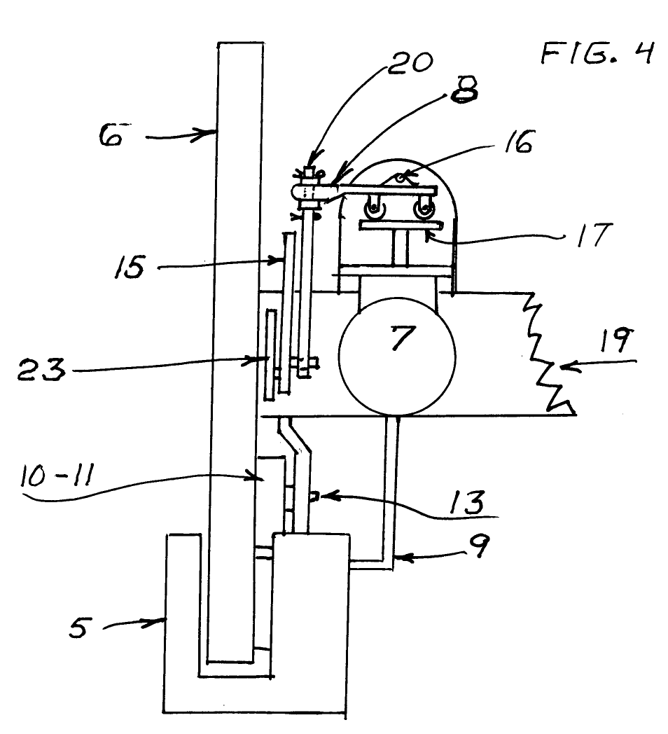

FIG. 4: Shows assembly looking down.

What I claim my invention is:

1. I am using a rotating disc, whether it is the disc brake rotor or one installed, for the purpose of having electro-magnets operate a mechanical linkage, to depress a piston in a hydraulic cylinder, which applies pressure on a piston in a disc brake caliper, squeezing the rotor creating a braking action.
